(19) United States
(12) Patent Application Publication
(10) Pub. No.: US 2017/0086444 A1
(43) Pub. Date: Mar. 30, 2017

(54) Fishing Gaff and Methods of Production Thereof

(71) Applicant: RYAN CHRISTOPHER MARTIN, BONITA, CA (US)

(72) Inventor: RYAN CHRISTOPHER MARTIN, BONITA, CA (US)

(21) Appl. No.: 14/868,141

(22) Filed: Sep. 28, 2015

(51) Int. Cl. A01K 97/14; B29C 65/48; B29C 65/56

(52) U.S. Cl. CPC A01K 97/14; B29C 65/561; B29C 65/483; B29K 2063/00

(57) ABSTRACT

In one aspect, a fishing gaff includes a shaft, at least a first grip circumscribing a grip end segment of the shaft, and a hook member engaged with a hook end segment of the shaft. The hook end segment of the shaft is opposite to and longitudinally spaced from the grip end segment of the shaft. The hook member includes a shank extending longitudinally along the hook end segment of the shaft, an engagement segment located proximally on the shank and extending transversely away from the shank into a transversely-oriented hole of the hook end segment of the shaft, and a piercing element configured to pierce fish that is located distally on the shank. The piercing element extends distally beyond a distal end of the shaft. The fishing gaff also includes a coupling member disposed circumferentially around the shank to hold the shank onto the shaft.

### FIELD

The present application relates generally to gaffs for hooking objects such as fish.

### BACKGROUND

Fishing gaffs are often used to pull a fish on board of a fishing vessel for capture after the fish has been reeled in close to the fishing vessel.

### SUMMARY

As recognized herein, current gaffs are heavy and/or not durable.

Accordingly, in one aspect a fishing gaff includes an elongated straight shaft, at least a first grip circumscribing a grip end segment of the elongated straight shaft, and a hook member engaged with a hook end segment of the elongated straight shaft. The hook end segment of the shaft is opposite to and longitudinally spaced from the grip end segment of the shaft. The hook member includes a shank extending longitudinally along the hook end segment of the elongated straight shaft, an engagement segment located proximally on the shank and extending transversely away from the shank into a transversely-oriented hole of the hook end segment of the elongated straight shaft, and a piercing element configured to pierce fish that is located distally on the shank. The piercing element extends distally beyond a distal end of the elongated straight shaft. The fishing gaff also includes a coupling member disposed Circumferentially around at least a portion of the shank to hold the shank onto the elongated straight shaft.

In another aspect, a method for making a fishing gaff includes wrapping twine around a proximal segment of an elongated shaft to establish, a grip, boring a hole in a distal segment of the elongated shaft transversely to a long axis of the elongated shaft, and disposing, in the hole, a transverse post or a proximal segment of a shank having a distal end terminating in a hook to pierce fish such that the shank lies lengthwise against the shaft parallel to the long axis of the shaft with the transverse post oriented transverse to the long axis while disposed in the hole. The method also includes wrapping a fiberglass material around at least a portion of the shank and shaft, disposing an epoxy over the fiberglass material, and wrapping twine around the epoxy.

In still another aspect, a fishing gaff includes an elongated shaft, at least a first grip circumscribing a grip end segment of the elongated shaft, and a hook member engaged with a hook end segment of the elongated shaft. The hook end segment of the shaft is opposite to and longitudinally spaced from the grip end segment of the shaft, and the hook member includes a piercing element configured to pierce fish. The fishing gaff also includes a coupling element disposed circumferentially around at least a portion of the hook member to hold the hook member onto the elongated shaft. The coupling element includes a fiberglass material disposed around at least a portion of the hook member and the elongated shaft, as well as an epoxy disposed over at least a portion of the fiberglass material.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The details of present principles, both as to their structure and operation, can best be understood in reference to the accompanying drawings, in which like reference numerals refer to like parts, and in which:

### BRIEF DESCRIPTION OF THE DRAWINGS

FIGS. 1 and 2 are diagrams of example gaffs in accordance with present principles;

FIGS. 3-5 are flow charts showing manufacturing steps for production of gaffs in accordance with present principles; and

FIGS. 6-8 are diagrams of portions of example gaffs during various stages of manufacturing.

### DETAILED DESCRIPTION

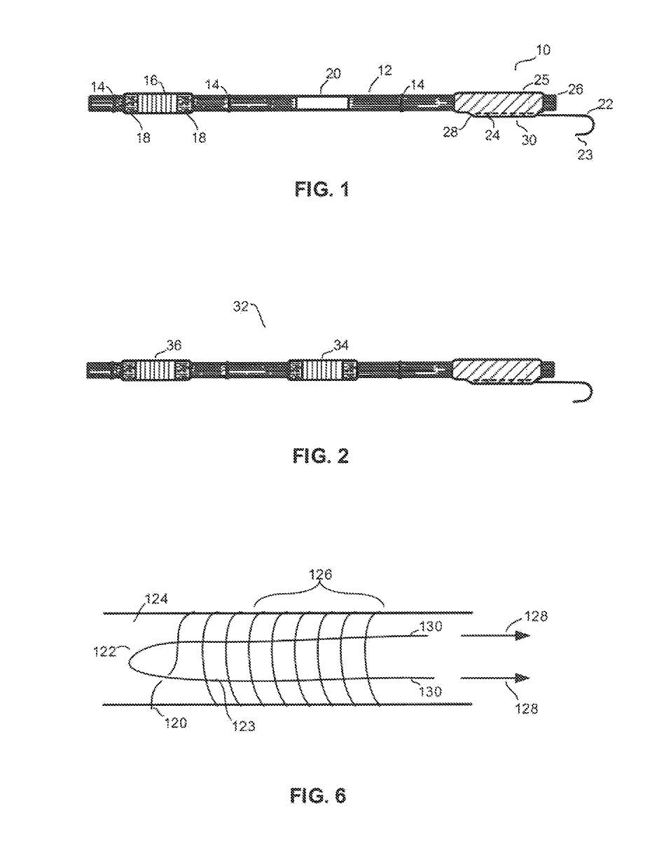

Reference is initially made to FIG. 1. This figure shows a fishing gaff 10 in accordance with present principles. The gaff 10 includes an elongated straight shaft 12 made of bamboo and/or other another relatively lightweight wood or other material (e.g., metal, graphite, plastic or another polymer, etc.). In embodiments where the shaft 12 is established by a piece of bamboo wood, the shaft 12 may have one or more nodes 14 separating hollow interior longitudinal segments of the shaft 12. The gaff 10 also includes at least one grip 16 circumscribing the shaft 12 at a proximal end segment of the shaft 12, the grip 16 having ends 18 thereof coated with a clear epoxy finish that also coats much of the shaft 12 as represented by the horizontal line shading shown. The grip 16 may be made of twine and examples of it will be described further below.

The shaft 12 of the gaff 10 may also have at feast one portion 20 that has not been coated with the clear epoxy finish and that has not been covered with twine. The portion 20 may not (at least initially) be coated with the clear epoxy finish or another sealant owing to the portion 20 being supported by a block when the shaft 12 is rotated using a relatively low rotations per minute (RPM) rotisserie motor device (referred to herein as a “Mow RPM motor device” for simplicity) during the manufacturing process as well be described further below. However, note that at later steps in the manufacturing process, another grip may be placed on the portion 20 as shown in FIG. 2, where a gaff 32 similar in many respects to the gaff 10 includes a grip 34 on the elongated straight shaft 12 that is longitudinally spaced from another grip 36 that may be at least substantially similar to the grip 16 described above. In other embodiments, later in the manufacturing process the portion 20 may be covered by an aesthetically pleasing structure and/or design, and/or may fee coated with the clear epoxy finish.

Still in reference to FIG. 1, the gaff 10 also includes a hook member 22 engaged with an end segment of the shaft 12 opposite to and longitudinally spaced from the end segment of the shaft 12 bearing the grip 16. The hook member 22 may be engaged via an engagement member thereof with a transversely-oriented hole in the shaft 12 (not shown in FIG. 1 for clarity). Furthermore, the hook member 22 includes a piercing element 23 configured to pierce fish that is located distally on a shank of the hook member 22 and that extends distally beyond the distal end of the shaft 12 as shown.

Dotted lines 24 illustrate that the shank of the hook member 22 extending longitudinally along a portion of the shaft 12 from the distal end as shown and to the hole lies lengthwise against the shaft 12 parallel to the longitudinal axis of the shaft 12, and is covered by a coupling member 25 that is disposed circumferentially around at least a portion of the shank of the hook member 22 to hold the shank of the hook member 22 against the elongated straight shaft 12. The coupling member may comprise Kevlar (and/or another similar high strength material), fiberglass material and/or fiberglass wrap, as well as an epoxy resin material, twine, and/or a clear epoxy finish as will be described further below. Note that in some embodiments, the coupling member 25 that extends longitudinally along the portion of the shaft 12 as shown need not cover to the distal end of the shaft 12 adjacent to the hook member 22 and that a portion 26 at the distal end of the shaft 12 may still be exposed (e.g., save for being coated with the clear epoxy finish). Also note that a portion 28 of the coupling member 25 comprising the fiberglass material, epoxy resin material, twine, and/or a clear epoxy finish may extend longitudinally beyond the portion of the shaft 12 at which the hole is located (e.g., one inch beyond) toward the proximal end of the shaft 12. Thus, as may be appreciated from FIG. 1, the portion of the shaft 12 not comprising the coupling member 25 may have a first radius, while the portion 28 has a second radius larger than the first, and while a portion 30 comprising both the coupling member 25 and the shank of the hook member 22 covered by the coupling member 25 may be thicker than the portion 28 in at least one dimension owing to the coupling member 25 being juxtaposed over the hook.

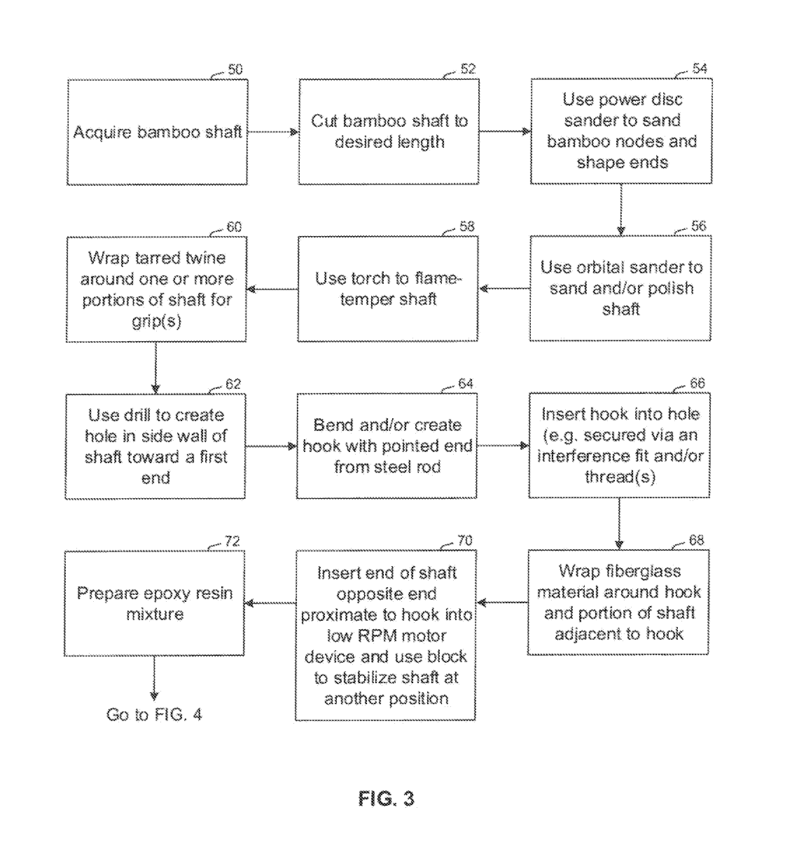

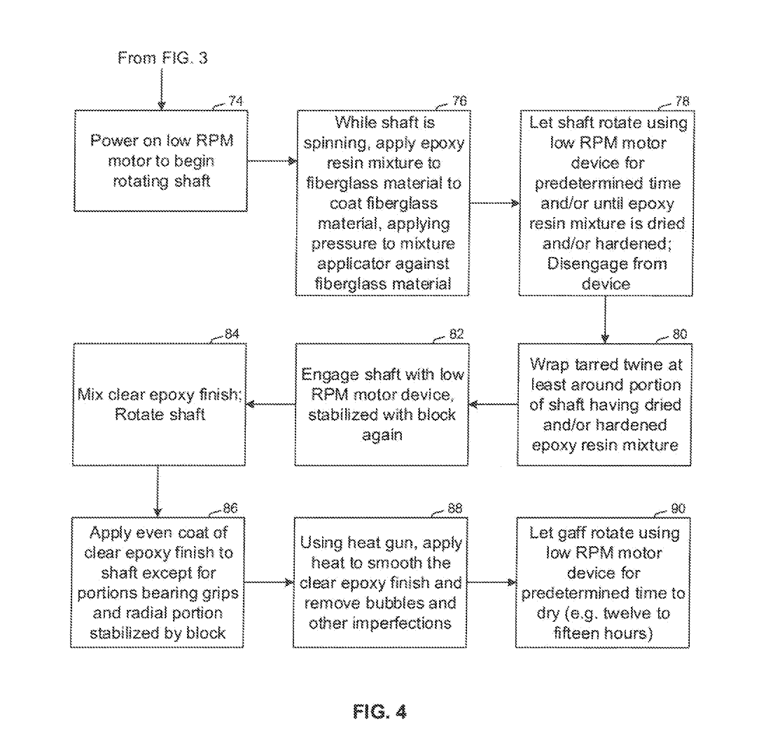

Continuing the detailed description in reference to FIG. 3, it shows an example flow chart of steps that may be taken to manufacture a fishing gaff such as the gaffs 10 and 32 in accordance with present principles. Beginning at step 50, the manufacturer acquires a raw bamboo shaft (and/or a shaft made of another relatively light-weight material). Then at step 52 the manufacturer cuts the bamboo shaft to a desired length, such as using a hack saw (e.g., a saw with thirty two teeth per inch). In some examples, the shaft may be cut so that respective ends thereof terminate at bamboo nodes so that no hollow interior segments of the bamboo are exposed at the ends.

After step 52, the manufacturer may continue to step 54 where the manufacturer uses a power disc sander to sand the shaft. An eighty grit sanding disc may be used at step 54, though it is to be understood that still other grit sizes may be used in accordance with present principles. In any case, the sanding at step 54 may include sanding all exterior surfaces of the shaft, including sanding portions of the bamboo nodes between ends of the shaft that protrude away from the shaft so that they are at least substantially flush with the rest of the shaft between the nodes. Both the proximal and distal ends of the shaft, which may terminate at bamboo nodes, may also be sanded so that the wood at the ends is at least substantially flat along a plane orthogonal to an axis established by the length of the shaft, save for the circumferences of the respective ends being rounded and/or curved with the disk sander in some examples. Thus, owing to the proximal and distal ends terminating at bamboo nodes, hollow interior segments of the bamboo wood adjacent to the ends are not accessible via the ends because the exposed area at each end of the shaft along the plane described above is occupied by wood from the node.

From step 54 the manufacturer may proceed to step 56, where the manufacturer may use an orbital sander to further sand and/or polish some or all of the exterior surfaces of the shaft. The grit size for sanding and polishing with the orbital sander may be, in some examples, one hundred fifty grit to two hundred twenty grit.

Thereafter, the manufacturer may move to step 58 where a torch (e.g., a propane torch) is used to flame-temper the shaft. The shaft may be flame-tempered on all exterior surfaces from one end of the shaft to the other and at the ends as well. To flame-temper the shaft, the end of the flame torch producing the flame may be positioned one to two inches away from the portion of the to be flame-tempered and the flame is then directed toward the shaft. Note, however, that this end of the flame torch may be positioned closer or farther away from the shaft depending on the time available to flame temper and desired degree of flame tempering.

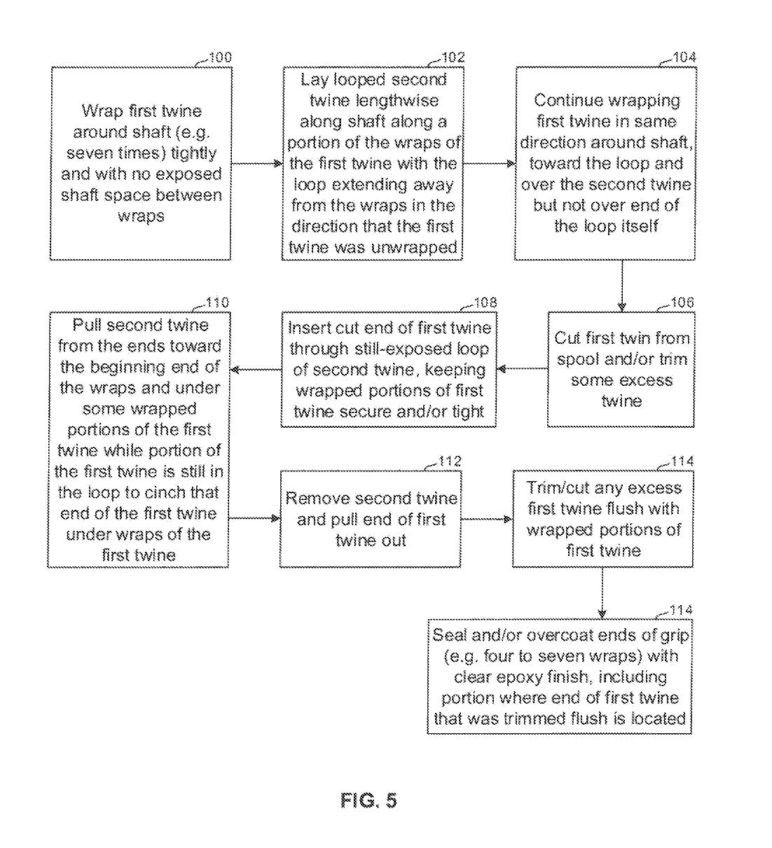

After step 58 the manufacturer may then proceed to step 60, where a material such as tarred twine may be wrapped around one or more portions of the shaft (e.g., including at least a proximal segment of the shaft) to respectively establish one or more grips. The procedure for wrapping the material around the portions of the shaft to establish the grips will be described further below in reference to FIGS. 5 and 6. In any case, after step 60 the manufacturer may move to step 62, where the manufacturer uses a drill to bore a hole transversely to a long axis of the shaft into a distal segment of the shaft.

The hole position relative to the distal end of the shaft that is to bear the hook member may be dependent on the size of the hook member to be used for the gaff, the length of the shaft itself, and/or the diameter of the shaft, so that for shorter hook members, shorter shafts, and/or larger diameters the hook member is placed nearer the distal end of the shaft than for longer hook members, longer shafts, and/or smaller diameters. For example, a ratio of total shaft length-to-length to hole from distal end may be used, where in example embodiments the ratio is one foot to half an inch. Thus, as one example, this may result in the hole being bored three and a half inches to five and a half inches from the distal end of the shaft.

Also in some examples, the size and/or length of the hook member may also be dependent on the length of the shaft, so that longer hook members are used on longer shafts while shorter hook members are used on shorter shafts. For example, a ratio of shaft length-to-hook member length (e.g., length along straight and curved portions of the hook member combined) of one foot to one inch, or one foot to half an inch, may be used.

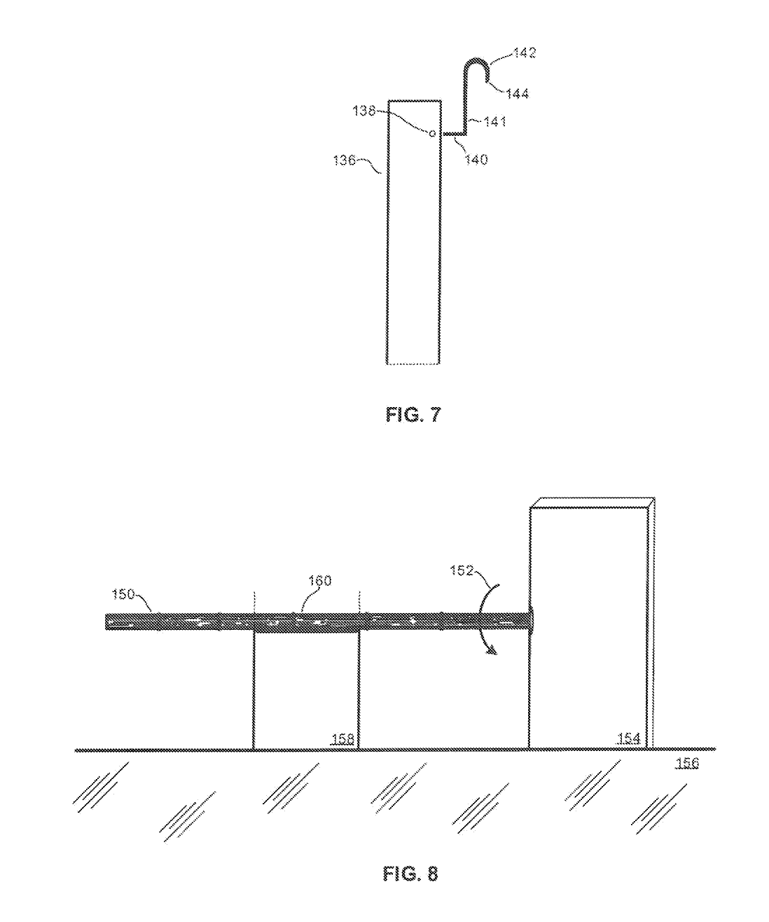

Still in reference to step 62, a drill bit may be selected, e.g., depending on the diameter of the shaft (e.g., an 11/64 (eleven sixty fourths) inch drill bit to an ⅛ (one eighth) inch drill bit for larger to smaller shaft diameters), to bore the hole in the shaft that has a diameter that is slightly larger than the diameter of a transverse post of a proximal segment of the hook member that is to be inserted transversely to the long axis of the shaft into the hole to thus establish an interference fit between the post of the hook member and the portion of the shaft around the hole while the post is disposed in the hole. Thus, at step 64 a hook member with a pointed and/or sharp distal hook end may be acquired or created from a piece of metal such as a stainless steel rod by bending and shaping the metal (e.g., under exposure to heat), and then at step 66 the transverse post of the hook member may be inserted into the hole. An example of such a shaft with a hole drilled in it and of a hook member to be engaged with the shaft, will be described below in reference to FIG. 7. Regardless, it is to be understood that although an interference fit may be used as described above (e.g., with force such as from a hammer being applied to tap the hook member down into the hole), the transverse post of the hook member may be screwed in as well using complimentary threads on the transverse post and threads in the shaft itself created when drilling the hole.

Still in reference to FIG. 3, from step 66 the manufacturer may proceed to step 68. At step 68 the manufacturer may apply Kevlar (and/or another para-aramid synthetic fiber) and/or fiberglass material, such as fiberglass tape and/or fiberglass cloth, (all collectively referred to below as “fiberglass material” for simplicity) at least around the portion of the shaft at which the hole is disposed toward the distal end of the shaft such that a foundation for the fiberglass material is established by the hook and/or shaft.

But in any case, the fiberglass material may be wrapped from the distal end of the shaft and at least to the portion of the shaft at which the hook member is engaged and/or secured if not farther, and optionally back again to the distal end using a single piece of fiberglass material. Thus, it is to be understood that in some embodiments multiple layers of fiberglass material may be used over top of each other, and also in some embodiments these multiple layers may be established by a unitary piece of fiberglass material that is wrapped back and forth. Three to five layers may be used in some examples, and in one specific example four layers may be wrapped around the shaft/hook member portion and, e.g., one inch past the hole at which the hook member is engaged. In the example of using four layers, and assuming the fiberglass material being used is fiberglass tape, approximately a four foot long segment of tape may be wrapped up and down the shaft between the distal end of the shaft and a point on the shaft past the hole by an inch, and the tape may not be further separated into additional segments such that the one unitary four foot piece is wrapped back and forth around this portion of the shaft.

More generally but still in reference to step 68, it is to be understood that the fiberglass material may be wrapped securely, tightly, and/or with pressure being applied so that the tape is taut as it is applied to the shaft and thus applies pressure to the hook member toward the shaft. For example, fiberglass tape may be wrapped by hand around the shaft and hook member as tight as possible (e.g., without breaking the tape).

Moving from step 68 to step 70, the manufacturer inserts, into a chuck of a low RPM and/or slow-spinning rotisserie motor device, the proximal end of the shaft opposite the distal end so that the motor in the device may be actuated to slowly rotate the shaft about its longitudinal axis. The low RPM motor device may thus be disposed on a flat horizontal surface so that the longitudinal axis of the shaft is parallel to the plane established by the surface. Also at step 70, if desired, a block ( e.g., block of wood) may be positioned under a portion of the shaft, such as half way between where it engages with the low RPM motor device and the distal end, to thus provide additional support and stabilization to the shaft as it is rotated so that it remains disposed horizontally above the surface on which the low RPM motor device is disposed.

After doing the foregoing at step 70, the manufacturer may then move to step 72 where the manufacturer prepares an epoxy resin mixture in a container. For example, a two-part marine epoxy resin mixture may be created with a ratio of five parts resin to one part hardener. Once combined, the materials may be mixed thoroughly in the container (e.g., by hand using a stick, brush, and/or rod), which in some instances may take approximately forty five seconds to one minute.

From step 72 as shown in FIG. 3, the manufacturer moves to step 74, which is shown in FIG. 4. At step 74 the manufacturer tens on the low RPM motor device to actuate the low RPM motor therein to cause the device to slowly rotate the shaft about its axis while the shaft is supported against gravity by the block placed under it at step 70. Thereafter, the manufacturer may move to step 76 where, with the shaft spinning and/or rotating under control of the low RPM motor device, the epoxy resin mixture prepared at step 72 may be applied over the fiberglass material that was wrapped around the shaft and hook member at step 68. The epoxy resin mixture may be applied on using an applicator such as a brush (e.g., smoothly brushing the epoxy resin mixture onto the fiberglass material) and may coat all exposed portions of the fiberglass material. Furthermore, the epoxy resin mixture may be applied while exerting pressure on the fiberglass material using the applicator to thus press at least some of the epoxy resin mixture into the fiberglass material (e.g., and even through the fiberglass material to contact and/or seep between the shaft and hook) so that, once the epoxy resin mixture is hardened, in one respect it “forms one unit” and/or is meshed with the fiberglass material.

After step 76, the manufacturer may move to step 78. At step 78 the manufacturer lets the shaft rotate using the low RPM motor device for a predetermined amount of time after applying the epoxy resin mixture and/or until the epoxy resin mixture is sufficiently dry, set, and/or hardened. Thus, in some examples, the shaft may continue to rotate using the low RPM motor device for twenty to thirty minutes. Then, also at step 78, the manufacturer may remove the shaft from the low RPM motor device and proceed to step 80.

At step 80 as shown in FIG. 4, the manufacturer may then wrap coils of a material such as tarred twine at least around the portion of the shaft that now bears the epoxy resin mixture such that the dried epoxy resin provides an acceptable foundation for the tarred twine. It is to also be understood that in some cases, the twine may be wrapped beginning, e.g., one inch before the end of the epoxy resin least proximate to the distal end of the shaft so that the twine is progressively coiled toward the distal end of the shaft bearing the hook member. An at least substantially similar, if not the same, method for wrapping the twine as was used for creating the grip at step 60 and as will be described further below may also be used for the twine wrapping that occurs at step 80, including the cinching which will be described below. In any case, the twine may be layered only once or more than once over the epoxy resin but is understood to, in either case, cover the epoxy resin such that no portions of the epoxy resin mixture and/or fiberglass material are visible. Note, however, that in some instances bamboo at the distal end of the shaft may still be exposed and/or visible, such as an eighth of an inch lengthwise.

After step 80, the shaft may again be engaged with the low RPM motor device at step 82 in the same manner as described above (e.g., while using the block as support). Then at step 84 the manufacturer may prepare a clear epoxy finish in a container for coating the gaff with it and then actuates the low RPM motor device to rotate the shaft. The clear epoxy finish may be a two-part mixture, one part resin and one part hardener, that is thoroughly mixed (e.g., for forty five seconds) in the container. In some instances, the clear epoxy finish may establish a flex coat finish.

After step 84, at step 86 the manufacturer may evenly apply (e.g. smoothly brush on using a brush) a coat of the clear epoxy finish to ail exposed surfaces of the gaff save exposed surfaces of the hook member, the portion being supported by the block, and portions bearing grips, though it is to also be understood that in some embodiments respective ends of each of the grips may be coated (e.g., half an inch to an inch of each end, lengthwise) with the clear epoxy finish as may be all exposed surfaces of the twine that was wrapped over the epoxy resin mixture that was applied at step 76 and sufficiently hardened at step 78. The gaff may be coated starting at the proximal end of the gaff, progressing toward the distal end.

Still in reference to FIG. 4, after the clear epoxy finish is applied at step 86, the manufacturer may move to step 88 where the manufacturer may, while the gaff is still rotating in the low RPM motor device, apply heat to all portions of the clear epoxy finish on the gaff, such as using a heat gun. In some examples, heat may be applied starting at the proximal end of the gaff with the manufacturer progressively applying heat toward and to the distal end as the gaff rotates. Application of the heat to the clear epoxy finish helps remove bubbles and imperfections in the clear epoxy finish on the gaff to make the finish more consistent, even, and/or smooth. Nonetheless, if application of the heat to the clear epoxy finish does not remove all visible imperfections and/or bubbles therefrom, a putty knife or other instrument may be used to help remove the imperfections and/or bubbles in the clear epoxy finish.

After step 88, the manufacturer may move to step 90 where the manufacturer lets the gaff continue to rotate using the low RPM motor device for a predetermined amount of time and/or until the clear epoxy finish dries and/or is sufficiently hardened (e.g., evenly with no drips and/or drip marks owing to the rotation). This may take twelve to fifteen hours of relatively slow rotation using the low RPM motor device, and performing step 90 in a well-ventilated area is beneficial as well. Also at step 90, once the clear epoxy finish has dried, the gaff may be removed from the low RPM motor device and is ready for distribution and/or vending.

Continuing the detailed description in reference to FIGS. 5 and FIG. 6, the process for wrapping twine around a gaff as disclosed herein, such as to create grips for the gaff, will be described. FIG. 5 shows a flow chart of steps taken by a manufacturer to accomplish this, while FIG. 6 illustrates one part in the process and will be discussed further below. Beginning first with step 100 of FIG. 5, material such as a first piece of tarred twine (called “first twine” below) is wrapped in a direction along a shaft to form part of a gaff in accordance with present principles, with the first twine being wrapped around the shaft tightly in successive coils and with no spaces in between successive coils such that no parts of the gaff under the coils are visible between successive coils the first twine. In example embodiments, this first step 100 of wrapping may be to wrap the first twine seven times around the shaft, if not more.

After step 100 the manufacturer moves to step 102 where the manufacturer lays a second piece of twine (called “second twine” below), with a portion forming a loop, lengthwise on the shaft over some but not all of the coils of the first twine with the loop extending away from the coils in the direction in which the first twine was wrapped along the shaft. Then at step 104 the manufacturer continues wrapping the first twine around the shaft in the same direction as before, toward the loop of the second twine, and over portions of the second twine not comprising the loop, again ensuring that the first twine is wrapped around the shaft tightly and with no spaces between successive coils of the first twine such that no part of the gaff under coils are visible between coils of the first twine.

From step 104 the manufacturer then moves to step 106 where the manufacturer cuts the first twine from a twine spool if still engaged therewith, and/or otherwise cuts some excess portions of the first twine while still leaving some excess first twine not wrapped around the shaft for the cinching to be described further below, such as leaving approximately one to four inches of excess first twine still connected to the wrapped portions. After step 106 the manufacturer moves to step 108 where, as may be seen in FIG. 6, the cut end of the first twine (element 120 in FIG. 6) is advanced through the still-exposed loop (element 122 of FIG. 6 ) of the second twine (element 123 of FIG. 6) on the shaft (element 124 of FIG. 6). Note that step 108 is performed while still keeping coils of the first twine (element 126 of FIG. 6) secured and/or tightly wrapped around the shaft 124 with no spaces in between successive coils as described above. It is to be understood, however, that FIG. 6 shows the coils 126 with some space existing therebetween merely for illustration, it also being noted that portions of the gaff as shown in FIG. 6 have been cut away for clarity, including the beginning end of the coils 126 which may be disposed to the right of the coils 126 shown in FIG. 6.

In any case, after step 108 the manufacturer proceeds to step 110. At step 110, the manufacturer pulls the second twine from its ends toward the beginning end of the coils of the first twine to pull the loop 122 under some coils of the first twine while at least a portion of the first twine is still in the loop 122 to thus cinch the end 120 of the first twine placed in the loop 122 under at least one, and even plural, coils 126 of the first twine. In FIG. 6, arrows 128 illustrate the direction that ends 130 of the second twine 123 are pulled (back toward the beginning end of the coils 126 of the first twine) so that end 120 of the first twine that was placed through the loop 122 is pulled under at least a few of the left-most coils 126 shown in FIG. 6 to thus cinch the end 120 under those coils while still keeping those coils and the others tightly wound around the shaft 124.

Again in reference to FIG. 5, after step 110 the manufacturer moves to step 112 where the second twine is pulled out and/or removed from under two coils of the first twine that were wrapped over it. The second twine may be pulled out from and/or removed from under those coils so that the free end of the first twine remains cinched under the coils if it was short enough to slip out of the loop of the second twine under the coils of the first twine while the loop was being pulled, or so that the free end of the first twine is pulled out with the second twine from between two of the coils. In another example, the second twine may be removed by pulling one end of it after a portion of the first twine near the free end thereof is cinched under the coils but the end itself of the first twine still protrudes away from the coils at the last of the coils that was wrapped and in the direction in which the coils were wrapped so that the free end of the first twine still protrudes away.

In any case, the second twine may then be discarded once removed. Furthermore, although not shown at step 112 on FIG. 5, it is to be understood that if the free end of the first twine came out from under two of the coils with the second twine, the free end may be pulled tight (e.g., without unraveling the coils at the end from which the loop was pulled), but regardless the coils themselves may be twisted by hand against the shaft to further tighten them and/or to remove any slack (e.g., in combination with pulling the free end of the first twine if it was pulled under and out from under two of the coils with the second twine).

The manufacturer then moves to step 114 where the manufacturer trims and/or cuts away any excess first twine that still remains at the free end of the first twine so that this end of the first twine when cut is flush with the coils of the first twine. Then at step 116 and/or as also described above in reference to step 86, both ends of the grip (e.g., four to seven coils of the first twine at both ends) are sealed and/over overcoated with the clear epoxy finish described above so that the end of the first twine trimmed flush at step 114, and the other end of the first twine at which the wrapping began, are both overcoated with clear epoxy finish and thus secure them to the gaff so that the coils of the first twine do not unravel.

Before moving on to the description of FIG. 7, it is to be understood in reference to FIG. 5 that though it was mentioned at a few steps above that the manufacturer may ensure that the first twine remains wrapped around the shaft tightly and with no spaces in between the coils such that no part of the gaff under the first twine is visible between coils of the first twine, this may be ensured at all steps shown in FIG. 5 so that after the clear epoxy finish sets and/or dries, the grip and/or aesthetic design that is created remains tightly wound around the shaft of the gaff with no spaces between successive coils. It is to also be understood that the total length of the grip that is created using the steps described in reference to FIG. 5 may be, e.g., ten inches or more. The length of the grips may also be dependent on the length of the shaft itself such that longer shafts have longer grips by a length ratio oft e.g., five to one or six to one.

Now in reference to FIG. 7, it shows an example elongated straight shaft 136 (with portions cut away for clarity) with a transversely-oriented hole 138 drilled into it as described above. The hole 138 may be threaded in example embodiments for an engagement segment 140 of the hook member 142 to screw transversely into the hole 138 using complimentary threads on the engagement segment 140, where the engagement segment 140 is located proximally to a shank 141 of the hook member 142 and extends transversely away from the shank 141. In addition to or in lieu of screwing, the hole 138 may be a size slightly bigger than the engagement segment 140 so that the engagement segment 140 engages the hole 138 in an interference fit. In any case, the hook member 142 also includes a piercing element 144 configured to pierce fish that is located distally on a shank 141.

Continuing the detailed description in reference to FIG. 8, it shows an example of a shaft 150 of a gaff in accordance with present principles while being rotated about its longitudinal axis as illustrated by arrow 152 using a low RPM motor device 154. The device 154 is disposed on a surface 156 and, to support the shaft 150 and keep its longitudinal axis at least substantially parallel to the surface 156 as it rotates, a block 158 is placed under a portion 160 of the shaft. If much of the shaft 150 were to be coated with clear epoxy finish as described above, the portion 160 may be left uncoated since application of the clear epoxy finish to it would cause the clear epoxy finish to transfer to the block 158 as well and possibly leak down onto the surface 156.

Accordingly, after other portions of shaft 150 to which the clear epoxy finish has been applied have set and/or dried, the block 158 may be moved thereto so that the portion 160 may be smoothly coated with clear epoxy finish and also allowed to set and/or dry as described above. In addition to or in lieu of the foregoing, the portion 160 may have twine wrapped around it and secured thereto as described above in reference to FIG. 5 so that the portion 160 may function as a grip and/or provide an otherwise aesthetically pleasing appearance even if not coated with the clear epoxy finish.

Generally, it is to be understood that in some embodiments, the wrapping and/or placement of materials on the shaft of the gaff, such as the first twine and fiberglass materials described above, may be done by hand without the aid of a machine, though in other embodiments a machine may be used.

Use of particular terminology when describing certain features or aspects herein should not be taken to imply that the terminology is being re-defined herein to be restricted to including any specific characteristics of the features or aspects of the technology with which that terminology is associated.

Accordingly, it is to be understood that the particular steps and sequences of steps described herein are examples and should not be read to limit the disclosure or the claims. Therefore, it is to be understood that in some instances, the functions and steps described herein may occur out of the example order shown in the figures. Even further, components included in one embodiment can be used in other embodiments in any appropriate combination. For example, any of the various components described herein and/or depicted in the figures may be combined, interchanged or excluded from other embodiments.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein are generally intended as “open” terms (e.g., the term “including” should be interpreted as “including but not limited to,” the term “having” should be interpreted as “having at least,” the term “includes” should be interpreted as “includes but is not limited to,” etc.) It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention. For example, “a system having at least one of A, B, and C” would include but not be limited to systems that have A alone, B alone, C alone, A and B together, A and C together, B and C together, and/or A, B, and C together, etc. (likewise for “a system having at least one of A, B, or C” and “a system having at least one of A, B, C”). Even further, “A system having one or more of A, B, and C” (likewise “a system having one or more of A, B, or C” and “a system having one or more of A, B, C”) includes systems that have A alone, B alone, C alone, A and B together, A and C together, B and C together, and/or A, B, and C together, etc.

It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” While various aspects and embodiments have been disclosed herein, other aspects and embodiments will be apparent to those skilled in the art. The various aspects and embodiments disclosed herein are for purposes of illustration and are not intended to be limiting.

While the particular FISHING GAFF AND METHODS OF PRODUCTION THEREOF is herein shown and described in detail, it is to be understood that the subject matter which is encompassed by the present application is limited only by the claims.

What is claimed is:

1. A fishing gaff, comprising:
an elongated straight shaft;
at least a first grip circumscribing a grip end segment of the elongated straight shaft;
a hook member engaged with a hook end segment of the elongated straight shaft, the hook end segment of the shaft being opposite to and longitudinally spaced from the grip end segment of the shaft, the hook member including a shank extending longitudinally along the hook end segment of the elongated straight shaft, the hook member including an engagement segment located proximally on the shank and extending transversely away from the shank into a transversely-oriented hole of the hook end segment of the elongated straight shaft, the hook member including a piercing element configured to pierce fish and located distally on the shank, the piercing element extending distally beyond a distal end of the elongated straight shaft; and
a coupling member disposed circumferentially around at least a portion of the shank to hold the shank onto the elongated straight shaft.

2. The gaff of claim 1, wherein the coupling member comprises para-aramid synthetic fiber and/or fiberglass.

3. The gaff of claim 2, wherein the coupling member comprises marine epoxy disposed over at least a portion of the para-aramid synthetic fiber and/or fiberglass.

4. The gaff of claim 1, wherein the coupling member comprises twine.

5. The gaff of claim 1, wherein the coupling member comprises a clear epoxy finish.

6. The gaff of claim 1, wherein the elongated straight shaft comprises at least an uncoated segment of the shaft not having a grip and not being coated with a clear epoxy.

7. The gaff of claim 1, wherein the elongated straight shaft is made of bamboo and distal and proximal ends of the shaft are established by bamboo nodes, such that no interior space of the shaft is exposed but instead is blocked by the nodes.

8. The gaff of claim 1, wherein the elongated straight shaft is made of metal.

9. The gaff of claim 1, wherein the elongated straight shaft is made of graphite.

10. The gaff of claim 1, wherein the first grip is made of twine, at least a portion of the first grip being coated with a clear epoxy finish.

11. The gaff of claim 1, comprising a second grip on the elongated straight shaft and longitudinally spaced from the first grip.

12. The gaff of claim 1, wherein the engagement segment is threaded and the hole is threaded.

13. A method for making a fishing gaff, comprising:
wrapping twine around a proximal segment of an elongated shaft to establish a grip;
boring a hole in a distal segment of the elongated shaft transversely to a long axis of the elongated shaft;
disposing, in the hole, a transverse post on a proximal segment of a shank having a distal end terminating in a hook to pierce fish, such that the shank lies lengthwise against the shaft parallel to the long axis of the shaft with the transverse post oriented transverse to the long axis while disposed in the hole;
wrapping a fiberglass material around at least a portion of the shank and shaft;
disposing an epoxy over the fiberglass material; and
wrapping twine around the epoxy.

14. The method of claim 13, wherein the elongated shaft is made of bamboo and distal and proximal ends of the elongated shaft are established by bamboo nodes such that no hollow interior segments of the shaft are exposed at the distal and proximal ends.

15. The method of claim 13, comprising screwing the transverse post into the hole.

16. The method of claim 13, comprising disposing a clear epoxy over the twine.

17. The method of claim 13, comprising rotating the shaft using a motor during the step of disposing the epoxy.

18. The method of claim 13, wherein the step of wrapping twine around the epoxy includes:
wrapping a first segment of twine in a first direction along the shaft with no spaces in between successive coils of the first segment of twine;
disposing a second segment of twine including a loop lengthwise on the shaft over some but not all of the coils of the first segment of twine with the loop extending away from the coils in the first direction; and
continuing to wrap the first segment of twine around the shaft in the first direction toward the loop of the second segment of twine, over portions of the second segment of twine not comprising the loop.

19. The method of claim 18, comprising:
advancing an end of the first segment of twine through the loop of the second segment of twine;
pulling the second segment of twine to cinch at least a portion of the first segment of twine; and
removing the second segment of twine from the first segment of twine.

20. A fishing gaff, comprising:
an elongated shaft;
at least a first grip circumscribing a grip end segment of the elongated shaft;
a hook member engaged with a hook end segment of the elongated shaft, the hook end segment of the shaft being opposite to and longitudinally spaced from the grip end segment of the shaft, the hook member including a piercing element configured to pierce fish; and
a coupling element disposed circumferentially around at least a portion of the hook member to hold the hook member onto the elongated shaft, the coupling element comprising a fiberglass material disposed around at least a portion of the hook member and the elongated shaft, the coupling element comprising an epoxy disposed over at least a portion of the fiberglass material.
